(19) United States
(12) Patent Application Publication
(10) Pub. No.: US 2017/0132161 A1
(43) Pub. Date: May 11, 2017

(54) I/O REQUEST PROCESSING METHOD AND STORAGE SYSTEM

(71) Applicant: Huawei Technologies Co., Ltd., Shenzhen (CN)

(72) Inventors: Yu HU, Chengdu (CN); Xu WEI, Chengdu (CN); Wei CHENG, Chengdu (CN)

(21) Appl. No.: 15/406,337

(22) Filed: Jan. 13, 2017

Related U.S. Application Data
(63) Continuation of application No. PCT/CN2015/080497, filed on Jun. 1, 2015.

(30) Foreign Application Priority Data
Jul. 15, 2014 (CN) 201410337244.9

(51) Int. Cl. G06F 13/16; G06F 13/42

(52) U.S. Cl. CPC G06F 13/1642; G06F 13/4282

(57) ABSTRACT

An input output (I/O) request processing method is applied to a storage system and includes: receiving an I/O request, where the I/O request carries a size and a to-be-accessed address of the I/O request; determining a type of a to-be-accessed storage device according to the to-be-accessed address; selecting, according to the size of the I/O and the determined device type, from M (physical layers) PHYs configured for the determined device type, a PHY for transmitting the I/O, where the PHYs configured for the storage device of this type are determined according to a total quantity of PHYs in the storage system, a percentage of a quantity of devices of this type in the storage system, and a size of an I/O received by the storage device of this type within a previous access period; and sending the I/O to the storage device by using the selected PHY.

### CROSS-REFERENCE TO RELATED APPLICATIONS

This application is a continuation of International Application No. PCT/CN2015/080497, filed on Jun. 1, 2015, which claims priority to Chinese Patent Application No. 201410337244.9, filed on Jul. 15, 2014. The disclosures of the aforementioned applications are hereby incorporated by reference in their entireties.

### TECHNICAL FIELD

The present disclosure relates to the field of storage technologies, and in particular, to an I/O request processing method and a storage system.

### BACKGROUND

A SAS (Serial Attached SCSI) standard is a manner for information exchange between SCSI (Small Computer Systems Interface) devices using SAS serial attached communication. In a storage system based on the SAS standard, in order to improve bandwidth utilization, an I/O (Input Output) is transmitted by selecting an idle PHY according to degrees of busyness of PHYs (Physical Layer,), so that a large quantity of PHYs are in a busy state, thereby improving the bandwidth utilization.

However, the foregoing technology has at least the following technical problem:

When PHYs are allocated to I/Os according to only degrees of busyness of the PHYs, bandwidth utilization is improved; however, when the I/Os have different sizes and storage devices to be accessed by the I/Os have different device types, an IOPS (I/O per second, a quantity of I/Os processed per second) of a storage system is relatively low.

### SUMMARY

The present disclosure provides an I/O request processing method and a storage system, which resolve a problem in the prior art that a data storage system has a relatively low IOPS.

According to a first aspect, the present disclosure provides an input output I/O request processing method, where the method is applied to a storage system, and the storage system includes a controller and storage devices of multiple different types, where the storage devices of the multiple different types are connected to the controller by using a serial attached Small Computer System Interface SAS, and the SAS includes multiple physical layers PHYs; and the method includes:

receiving an I/O request, where the I/O request carries a size and a to-be-accessed address of the I/O;

determining a device type of a to-be-accessed storage device according to the to-be-accessed address;

selecting, according to the size of the I/O and the determined device type, a PHY for transmitting the I/O from M PHYs configured for the storage device of the determined device type, where the PHYs configured for the storage device of the determined device type are determined according to a total quantity of PHYs in the storage system, a percentage of a quantity of devices of this type in the storage system, and a size of an I/O received by the storage device of this type within a previous access period, and M is a positive integer; and sending the I/O to the storage device by using the selected PHY.

With reference to the first aspect, in a first possible implementation manner of the first aspect, the selecting, according to the size of the I/O and the determined device type, from M PHYs configured for the storage device of this type, a PHY for transmitting the I/O includes:

determining the M PHYs from the multiple PHYs according to the determined device type, where all storage devices of this device type can communicate with the controller by using the M PHYs; and

selecting, from the M PHYs according to the size of the I/O, N PHYs for transmitting the I/O, where the N PHYs are used to transmit an I/O whose I/O size satisfies a preset condition, N is a positive integer, and N is not greater than M.

With reference to the first possible implementation manner of the first aspect, in a second possible implementation manner of the first aspect, where when N is a positive integer not less than 2, the method further includes:

selecting, according to degrees of busyness of the N PHYs, an idle PHY from the N PHYs as the PHY for transmitting the I/O.

With reference to the first aspect, the first possible implementation manner of the first aspect, or the second possible implementation manner of the first aspect, in a third possible implementation manner of the first aspect, the method further includes: allocating the M PHYs to the storage device of this type according to the total quantity of the PHYs in the storage system and the percentage of the quantity of storage devices of this type in the storage system; and

determining, in the M PHYs and according to statistical proportions of I/Os of different sizes accessing the storage device of this type within the previous access period, PHYs for processing I/Os of different sizes within a next access period.

With reference to the first aspect, the first possible implementation manner of the first aspect, or the second possible implementation manner of the first aspect, in a fourth possible implementation manner of the first aspect, the method further includes:

allocating the M PHYs to the storage device of this type according to the total quantity of the PHYs in the storage system and the percentage of the quantity of storage devices of this type in the storage system; and

determining, in the M PHYs and according to a preset policy, PHYs for processing I/Os of different sizes.

According to a second aspect, based on a same disclosure concept, the present disclosure provides a storage system, where the storage system includes a controller and storage devices of multiple different types, where the storage devices of the multiple different types are connected to the controller by using a serial attached Small Computer System Interface SAS, and the SAS includes multiple physical layer channels PHYs; and the controller is configured to:

receive an I/O request, where the I/O request carries a size and a to-be-accessed address of the I/O; determine a device type of a to-be-accessed storage device according to the to-be-accessed address; select, according to the size of the I/O and the determined device type, from M PHYs configured for the storage device of this type, a PHY for transmitting the I/O, where the PHYs configured for the storage device of this type are determined according to a total quantity of PHYs in the storage system, a percentage of a quantity of devices of this type in the storage system, and a size of an I/O received by the storage device of this type within a previous access period, and M is a positive integer; and send the I/O to the storage device by using the selected PHY.

With reference to the second aspect, in a first possible implementation manner of the second aspect, the controller is further configured to:

determine the M PHYs from the multiple PHYs according to the determined device type, where all storage devices of this device type can communicate with the controller by using the M PHYs; and select, from the M PHYs according to the size of the I/O, N PHYs for transmitting the I/O, where the N PHYs are used to transmit an I/O whose I/O size satisfies a preset condition, N is a positive integer, and N is not greater than M.

With reference to the first possible implementation manner of the second aspect, in a second possible implementation manner of the second aspect, where when N is a positive integer not less than 2, the controller is further configured to:

select, according to degrees of busyness of the N PHYs, an idle PHY from the N PHYs as the PHY for transmitting the I/O.

With reference to the second aspect, the first possible implementation manner of the second aspect, or the second possible implementation manner of the second aspect, in a third possible implementation manner of the second aspect, the controller is further configured to:

allocate the M PHYs to the storage device of the determined device type according to the total quantity of the PHYs in the storage system and the percentage of the quantity of storage devices of this type in the storage system; and determine, in the M PHYs according to statistical proportions of I/Os of different sizes accessing the storage device of this type within the previous access period, PHYs for processing I/Os of different sizes within a next access period.

With reference to the second aspect, the first possible implementation manner of the second aspect, or the second possible implementation manner of the second aspect, in a fourth possible implementation manner of the second aspect, the controller is further configured to:

allocate the M PHYs to the storage device of this type according to the total quantity of the PHYs in the storage system and the percentage of the quantity of storage devices of this type in the storage system; and determine, in the M PHYs according to a preset policy, PHYs for processing I/Os of different sizes.

The present disclosure has at least the following technical effects or advantages:

The present disclosure discloses an I/O request processing method, where the method is applied to a controller in a storage system, the storage system further includes storage devices of multiple different types, the storage devices of the multiple different types are connected to the controller by using a SAS interface, and the SAS interface includes multiple PHYs; and the method includes: receiving an I/O request, where the I/O request carries a size of the I/O and a to-be-accessed address; determining a device type of a to-be-accessed storage device according to the to-be-accessed address; and selecting, according to the size of the I/O and the determined device type, from M PHYs configured for the storage device of this type, a PHY for transmitting the I/O, where the PHYs configured for the storage device of this type are determined according to a total quantity of PHYs in the storage system, a percentage of a quantity of devices of this type in the storage system, and a size of an I/O received by the storage device of this type within a previous access period, and M is a positive integer. In the present disclosure, a PHY for transmitting an I/O is selected according to a size of the I/O and a device type of a storage device to be accessed by the I/O, which can effectively improve an IOPS of a storage system.

### BRIEF DESCRIPTION OF DRAWINGS

To describe the technical solutions in the embodiments of the present disclosure more clearly, the following briefly introduces the accompanying drawings required for describing the embodiments or the prior art. Apparently, the accompanying drawings in the following description show some embodiments of the present disclosure, and a person of ordinary skill in the art may still derive other drawings from these accompanying drawings without creative efforts.

FIG. 1 is a schematic structural diagram of a storage system according to an embodiment of the present disclosure;

FIG. 2 is a schematic diagram of an application scenario of an I/O request processing method according to an embodiment of the present disclosure;

FIG. 3 is a flowchart of an I/O request processing method according to an embodiment of the present disclosure; and

FIG. 4 is a detailed flowchart of step S13 according to an embodiment of the present disclosure.

### DESCRIPTION OF EMBODIMENTS

To make the objectives, technical solutions, and advantages of the embodiments of the present disclosure clearer, the following clearly describes the technical solutions in the embodiments of the present disclosure with reference to the accompanying drawings in the embodiments of the present disclosure. Apparently, the described embodiments are some but not all of the embodiments of the present disclosure.

### Embodiment 1

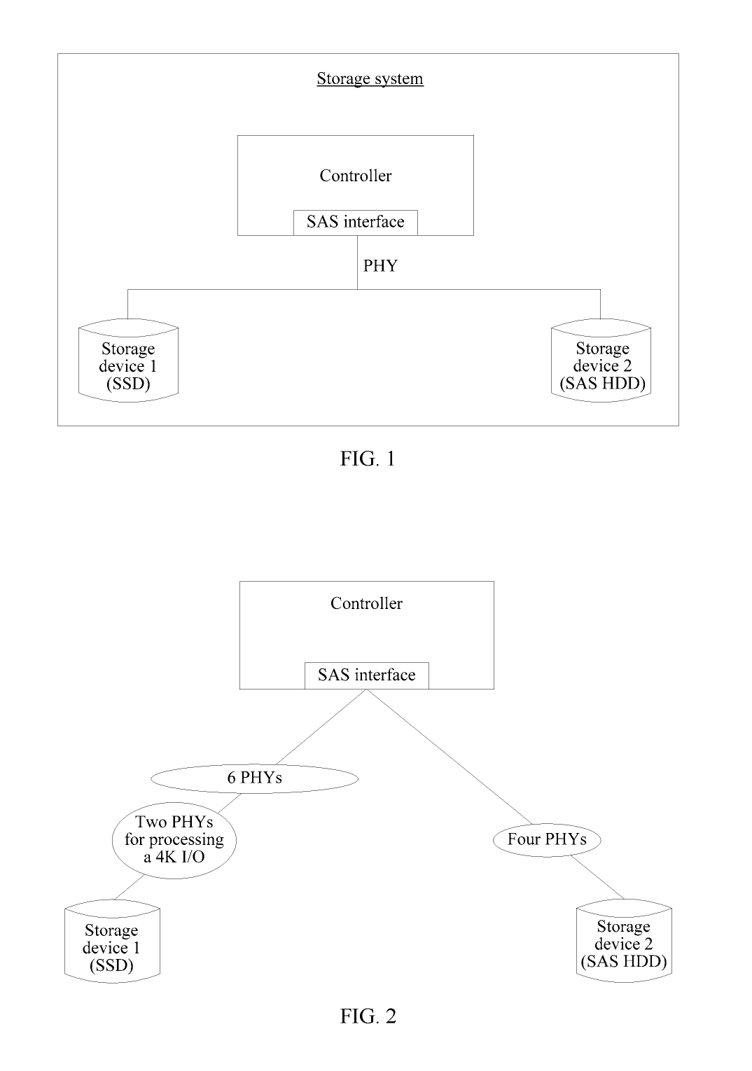

This embodiment provides an I/O request processing method, applied to a storage system shown in FIG. 1, where the storage system includes a controller and storage devices of multiple different types, and the storage devices of the multiple different types are connected to the controller by using a SAS interface, and the SAS interface includes multiple PHYs.

In a specific implementation process, the storage devices of the multiple different types specifically refer to: storage devices having different types of storage media. For example, as shown in FIG. 1, the storage system includes two types of storage devices (which are specifically: a storage device 1 and a storage device 2), and the two types of storage devices have different types of storage media, where a storage medium of the storage device 1 is an SSD (solid state disk), a storage medium of the storage device 2 is a SAS HDD (serial attached Small Computer System Interface hard disk drive). A quantity of storage devices of each type is not specifically limited herein.

In a specific implementation process, the SAS interface includes multiple PHYs, and the controller can communicate with each storage device in the storage system by using the PHYs. For example, as shown in FIG. 2, the SAS interface in the storage system includes 10 PHYs in total (which are specifically: a PHY 1, a PHY 2, a PHY 3, a PHY 4, a PHY 5, a PHY 6, a PHY 7, a PHY 8, a PHY 9, and a PHY 0), and the controller can deliver an I/O to each storage device in the storage system by using each of the 10 PHYs.

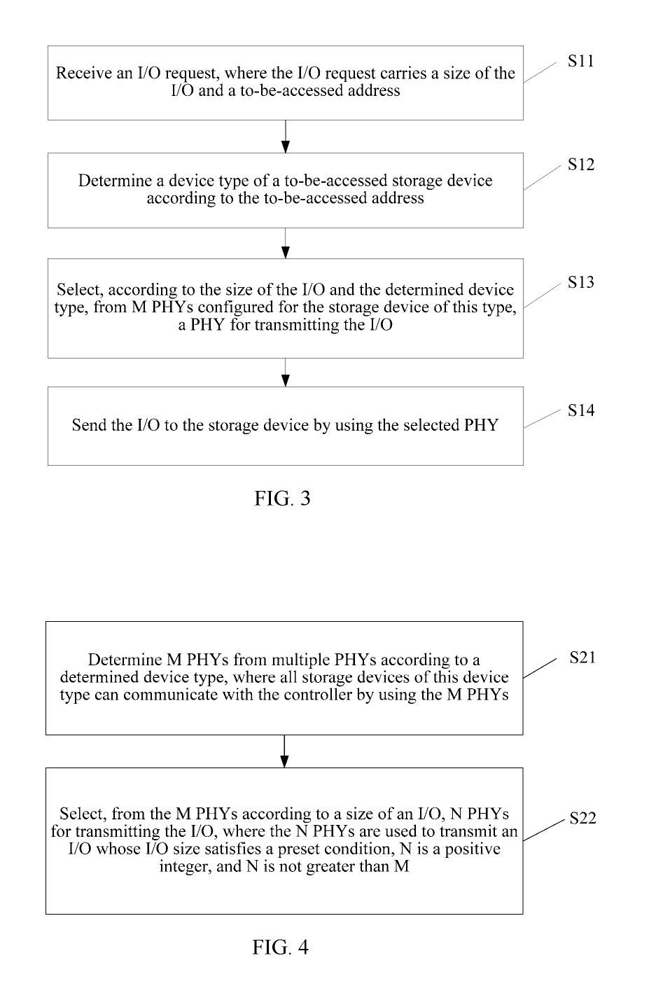

As shown in FIG. 3, the I/O request processing method is applied to the controller and includes:

Step S11: Receive an I/O request, where the I/O request carries a size of the I/O and a to-be-accessed address.

In a specific implementation process, the I/O request may be a data read request or a data write request; when the I/O request is a data write request, the I/O request further carries to-be-written data that needs to be written into a storage device. For example, as shown in FIG. 2, the I/O request is a data read request, and the size of the I/O in the I/O request is 4 K, and the corresponding to-be-accessed address is an address of the storage device 1.

In a specific implementation process, the size of the I/O specifically refers to a value of a total data volume included in the I/O request.

In the following description, an access period in which step S11 to step S14 are performed is referred to as a second access period, and an access period prior to the second access period is referred to as a first access period.

Step S12: Determine a device type of a to-be-accessed storage device according to the to-be-accessed address. For example, as shown in FIG. 2, it is determined, according to a correspondence between addresses of storage devices and device types of the storage devices, that the device type of a storage device to be accessed by the I/O is SSD.

Step S13: Select, according to the size of the I/O and the determined device type, from M PHYs configured for the storage device of this type, a PHY for transmitting the I/O. The PHYs configured for the storage device of this type are determined according to a total quantity of PHYs in the storage system, a percentage of a quantity of devices of this type in the storage system, and a size of an I/O received by the storage device of this type within a previous access period, and M is a positive integer.

For example, as shown in FIG. 2, six PHYs in total (for example, a PHY 1 to a PHY 6) are configured for the storage device of the SSD type; therefore, the PHY for transmitting the I/O needs to be selected from the six PHYs. The PHYs configured for the storage device of the SSD type are determined according to a total quantity of the PHYs in the storage system, a percentage of a quantity of devices of the SSD type in the storage system, and a size of an I/O received by the storage device of the SSD type within a previous access period (that is, the first access period).

Step S14: Send the I/O to the storage device by using the selected PHY. For example, as shown in FIG. 2, if the PHY 1 is selected as the PHY for transmitting the I/O, the I/O is sent to the storage device of the SSD type (that is, the storage device 1) by using the PHY 1.

Storage devices of a same type have different processing speeds for I/Os of different sizes, and storage devices of different types have different speeds for I/Os of a same size. Therefore, when PHYs are allocated to I/Os according to only degrees of busyness of the PHYs, bandwidth utilization can be improved, but a relatively low IOPS of a storage system is caused. In this embodiment, a PHY for transmitting an I/O is selected according to a size of the I/O and a device type of a storage device to be accessed by the I/O, which can effectively improve an overall IOPS of a storage system.

Optionally, in this embodiment, as shown in FIG. 4, step S13 includes:

Step S21: Determine the M PHYs from the multiple PHYs according to the determined device type, where all storage devices of this device type can communicate with the controller by using the M PHYs.

In a specific implementation process, before the first access period ends (or before the second access period starts), the controller already configures PHYs that are used by storage devices of each type within the second access period. For example, as shown in FIG. 2, in the storage system, before the first access period ends (or before the second access period starts), the controller already configures six PHYs (for example, a PHY 1, a PHY 2, a PHY 3, a PHY 4, a PHY 5, and a PHY 6) for the storage device of the SSD type and configures four PHYs (for example, a PHY 7, a PHY 8, a PHY 9, and a PHY 0) for the storage device of the SAS HDD type. When it is determined that the to-be-accessed storage device is of the SSD type, six PHYs preconfigured for a storage device of the SSD type can be determined from the 10 PHYs of the storage system.

Step S22: Select, from the M PHYs according to the size of the I/O, N PHYs for transmitting the I/O, where the N PHYs are used to transmit an I/O whose I/O size satisfies a preset condition, N is a positive integer, and N is not greater than M.

In a specific implementation process, the N PHYs are specifically used to transmit I/Os whose I/O sizes are within a preset interval. Based on an interval in which the size of the I/O to be transmitted is located, the N PHYs for transmitting I/Os that are within this interval may be selected from the M PHYs. For example, as shown in FIG. 2, the controller further classifies the six PHYs allocated to the storage device of the SSD type, where the PHY 1 and the PHY 2 are used to transmit I/Os within an interval of 0 to 16 K, the PHY 3 and the PHY 4 are used to transmit I/Os within an interval of 17 K to 32 K, and the PHY 5 and the PHY 6 are used to transmit I/Os within an interval of 33 K to 48 K. When a size of an I/O to be transmitted is 4 K, it is determined, based on the size of the I/O to be transmitted, that an interval in which the I/O is located is 0 to 16 K, and therefore, it is determined that the PHY 1 and the PHY 2 are PHYs for transmitting the 4-K I/O.

Further, when N is a positive integer not less than 2, the method further includes:

randomly selecting a PHY from the N PHYs as the PHY for transmitting the I/O; for example, as shown in FIG. 2, a PHY is randomly selected from the PHY 1 and the PHY 2 to serve as the PHY for transmitting the I/O;

or

selecting, according to degrees of busyness of the N PHYs, an idle PHY from the N PHYs as the PHY for transmitting the I/O; for example, as shown in FIG. 2, if the PHY 2 is in a busy state, and the PHY 1 is in an idle state, the PHY 1 is selected as the PHY for transmitting the I/O.

Optionally, in this embodiment, the method further includes:

allocating the M PHYs to the storage device of this type according to the total quantity of the PHYs in the storage system and the percentage of the quantity of storage devices of this type in the storage system; and

determining, in the M PHYs according to a preset policy, PHYs for processing I/Os of different sizes; for example, PHYs for processing I/Os of different sizes within a next access period (that is, the second access period) are determined in the M PHYs according to statistical proportions of I/Os of different sizes accessing the storage device of this type within the previous access period (that is, the first access period).

In a specific implementation process, PHYs, for processing I/Os of different sizes, of a storage device of each type within the second access period are determined based on the following algorithm.

(1) P intervals are determined for all I/Os in the storage system within the first access period based on different sizes of the I/Os, and each interval is numbered. For example, 0 to 16 K is an interval and is numbered 1, 17 K to 32 K is an interval and is numbered 2, 32 K to 48 K is an interval and is numbered 3, and so on, to obtain P intervals numbered 1 to P.

(2) When the storage system includes storage devices of Q different types in total, a storage device of each type is numbered. For example, when the storage system includes storage devices of three types in total: SDD, SAS SDD, and DISK, a storage device of the SDD type is numbered 1, a storage device of the SAS SDD type is numbered 2, a storage device of the DISK type is numbered 3, and so on, to obtain Q storage device types numbered 1 to Q.

(3) An interval in which each I/O in all I/Os received by the storage system within the first access period is located and a device type of a storage device to be accessed are determined; all the I/Os received by the storage system within the first access period are classified into P×Q categories, and a quantity of I/Os of each category is counted; herein, the quantity of I/Os of each category is referred to as a first count of each I/O category, and is expressed as IOcnt₁ (j, i ). i is a number of an interval, and a value thereof is any integer from 1 to P; j is a number of a device type, and a value thereof is any integer from 1 to Q.

(4) Because storage devices of different types have different processing speeds for each I/O category, an influence factor is separately set for each I/O category, and the influence factor is specifically determined based on formula (a):

$$a ( j , i ) = \frac{IOPS ( j , i )}{{\sum }_{j = 1}^{Q} IOPS ( j , i )} \qquad ( a )$$

where a (j, i) is an influence factor of an I/O that is going to access a storage device of a device type numbered j and that is in an interval numbered i; and IPOS (j, i) is a maximum IOPS that can be achieved when the storage device of the device type numbered j processes the I/O in the interval numbered i.

(5) A first percentage, of a quantity of PHYs allocated within the second access period to each I/O category among the P×Q I/O categories, to a total quantity of PHYs is determined according to formula (b):

$${per}_{1} ( j , i ) = \frac{{IOcnt}_{1} ( j , i ) \times a ( j , i )}{{\sum }_{j = 1}^{M} [ {IOcnt}_{1} ( j , i ) \times a ( j , i ) ]} \qquad ( b )$$

where per₁ (j, i) is a first percentage, of a quantity of PHYs allocated within the second period to I/Os that are going to access a storage device of a device type numbered j and that are in an interval numbered i, to the total quantity of the PHYs, and IOcnt₁ (j, i) is a first count of I/Os that are going to access the storage device of the device type numbered j and that are in the interval numbered i.

(6) For each type among the Q types, a second percentage, of a quantity of PHYs allocated to I/Os that are going to access a storage device of this type, to the total quantity of the PHYs is determined according to formula (c):

$${per}_{2} ( j ) = \frac{{\sum }_{j = 1}^{M} {per}_{1} ( j , i )}{P} \qquad ( c )$$

where per₂ (j) is a second percentage, of a quantity of PHYs allocated within the second access period to I/Os that are going to access a storage device of a type numbered j, to the total quantity of the PHYs.

(7) For each type among the Q types, a quantity of PHYs allocated within the second period to I/Os that are going to access a storage device of this type is determined according to formula (d):

Num(j)=per₂(j)×B (d)

where Num(j) is a quantity of PHYs allocated within the second period to I/Os that are going to access a storage device of a type numbered j, and B is the total quantity of the PHYs in the storage system.

(8) If a quantity of PHYs allocated within the second period to I/Os that are going to access a storage device of a type numbered x is greater than or equal to 2, a second count of I/Os that are going to access the storage device of the type numbered x and that are in an interval numbered i is obtained according to formula (e):

$${IOcnt}_{2} ( x , i ) = \frac{{IOcnt}_{1} ( x , i )}{{IOsize}_{max} ( i )} \qquad ( e )$$

where IOcnt₂ (x, i) is the second count of I/Os that are going to access the storage device of the type numbered x and that are in the interval numbered i; IOcnt₁ (x, i) is a first count of I/Os that are going to access the storage device of the type numbered x and that are in the interval numbered i; and IOsizeₘₐₓ (i) is an upper limit value of the interval numbered i; for example, an upper limit value of an interval of 0 to 16 K is 16 K.

(9) A third percentage, of a quantity of PHYs required to be allocated within the second period to I/Os that are going to access the storage device of the type numbered x and that are in the interval numbered i, to the total quantity of the PHYs is obtained according to formula (f):

$${per}_{3} ( x , i ) = \frac{{IOcnt}_{2} ( x , i )}{{\sum }_{i = 1}^{P} {IOcnt}_{2} ( x , i )} \qquad ( f )$$

where per₃ (n, i) is the third percentage, of the quantity of the PHYs required to be allocated within the second period to I/Os that are going to access the storage device of the type numbered x and that are in the interval numbered i, to the total quantity of the PHYs; and IOcnt₂ (x, i) is the second count of I/Os that are going to access the storage device of the type numbered x and that are in the interval numbered i.

(10) The quantity of the PHYs allocated within the second period to I/Os that are going to access the storage device of the type numbered x and that are in the interval numbered i is determined according to formula (g):

Num(x, i)=per₃(x)×B (g)

where Num(x, i) is a quantity of the PHYs required to be allocated within the second period to I/Os that are going to access the storage device of the type numbered x and that are in the interval numbered i.

In this embodiment, because I/Os of a same type (that is, I/Os that are going to access storage devices having a same device type number and that have a same interval number) are sent by using same PHYs, so that small I/Os can be preferentially transmitted and stored, thereby improving overall IOPS performance of a storage system.

An application scenario of this embodiment of the present disclosure is: For a mixture of I/Os of different sizes and a mixture of the SSD and SAS HDD in hierarchical storage, multiple scenarios are applied, which can improve overall performance of a storage system, and especially, decreases a delay for processing small I/Os in mixed services.

An application scope of this embodiment of the present disclosure is all storage systems using a SAS backend.

A group of experimental data is provided below. As shown in Table 1, in the experiment, two service models are used to compare a traditional scheme with a scheme in this embodiment of the present disclosure, where in the traditional scheme, PHYs are allocated to I/Os according to degrees of busyness of the PHYs. It can be known from the experimental data in Table 1 that an IOPS is improved by 10% to 30% approximately by using a prototype established according to the two service models of this embodiment of the present disclosure.

TABLE 1

| | | | Scheme in this | | | |
|---|---|---|---|---|---|---|
| | Traditional scheme | | embodiment | | IOPS | Bandwidth |
| | | Bandwidth | | Bandwidth | improvement | improvement |
| Service models | IOPS | (KB/S) | IOPS | (KB/S) | percentage | percentage |
| Model 1: | 113243 | 1470100 | 152287 | 1241077 | 34.48% | −18.45% |
| 64K + 16K + 4K + | | | | | | |
| 512 B (read in a | | | | | | |
| mixed sequence) | | | | | | |
| Model 2: | 131952 | 900573 | 149870 | 913025 | 13.58% | 1.38% |
| 128K + 512 B (read | | | | | | |
| in a mixed sequence) | | | | | | |

The foregoing technical solution in this embodiment of this application has at least the following technical effects or advantages:

In this embodiment, PHYs are dynamically allocated according to different sizes of I/Os and different storage media, which increases the utilization of the PHYs and improves overall IOPS performance of a storage system.

### Embodiment 2

Based on a same disclosure concept, as shown in FIG. 1, this embodiment provides a storage system, where the storage system includes a controller and storage devices of multiple different types, where the storage devices of the multiple different types are connected to the controller by using a SAS interface, and the SAS interface includes multiple PHYs; and the controller is configured to:

receive an I/O request, where the I/O request carries a size of the I/O and a to-be-accessed address; determine a device type of a to-be-accessed storage device according to the to-be-accessed address; select, according to the size of the I/O and the determined device type, from M PHYs configured for the storage device of this type, a PHY for transmitting the I/O, where the PHYs configured for the storage device of this type are determined according to a total quantity of PHYs in the storage system, a percentage of a quantity of devices of this type in the storage system, and a size of an I/O received by the storage device of this type within a previous access period, and M is a positive integer; and send the I/O to the storage device by using the selected PHY.

In the present disclosure, a PHY for transmitting an I/O is selected according to a size of the I/O and a device type of a storage device to be accessed by the I/O, which can effectively improve an IOPS of a storage system.

Optionally, in this embodiment, the controller is further configured to:

determine the M PHYs from the multiple PHYs according to the determined device type, where all storage devices of this device type can communicate with the controller by using the M PHYs; and select, from the M PHYs according to the size of the I/O, N PHYs for transmitting the I/O, where the N PHYs are used to transmit an I/O whose I/O size satisfies a preset condition, N is a positive integer, and N is not greater than M.

Optionally, in this embodiment, when N is a positive integer not less than 2, the controller is further configured to:

select, according to degrees of busyness of the N PHYs, an idle PHY from the N PHYs as the PHY for transmitting the I/O.

Optionally, in this embodiment, the controller is further configured to:

allocate the M PHYs to the storage device of this type according to the total quantity of the PHYs in the storage system and the percentage of the quantity of storage devices of this type in the storage system; and determine, in the M PHYs according to statistical proportions of I/Os of different sizes accessing the storage device of this type within the previous access period, PHYs for processing I/Os of different sizes within a next access period.

Optionally, in this embodiment, the controller is further configured to:

allocate the M PHYs to the storage device of this type according to the total quantity of the PHYs in the storage system and the percentage of the quantity of storage devices of this type in the storage system; and determine, in the M PHYs according to a preset policy, PHYs for processing I/Os of different sizes.

A person skilled in the art may clearly understand that, the technologies in the embodiments of the present disclosure may be implemented by software in addition to a necessary general hardware platform. Based on such an understanding, the technical solutions in the embodiments of the present disclosure essentially, or the part contributing to the prior art may be implemented in the form of a software product. The computer software product is stored in a storage medium, such as an ROM/RAM, a magnetic disk, or an optical disc, and includes several instructions for instructing a computer device (which may be a personal computer, a server, or a network device) to perform the methods described in the embodiments or some parts of the embodiments of the present disclosure.

Finally, it should be noted that the foregoing embodiments are merely intended for describing the technical solutions of the present disclosure, but not for limiting the present disclosure. The embodiments provided in the present application are merely exemplary. A person skilled in the art may clearly understand that, for the purpose of convenient and brief description, in the foregoing embodiments, the descriptions of the embodiments have their respective focuses. For a part that is not described in detail in an embodiment, reference may be made to related descriptions in other embodiments. Features disclosed in the embodiments of the present disclosure, claims, and drawings may independently exist or exist in a combination.

1. An input output (I/O) request processing method, comprising:
receiving, by a controller, an I/O request, wherein the I/O request carries a size and a to-be-accessed address of the I/O request, wherein the controller is connected to storage devices of multiple different device types by a serial attached Small Computer System Interface (SAS), and the SAS comprises multiple physical layers (PHYs);
determining, by the controller, a device type of a to-be-accessed storage device according to the to-be-accessed address;
selecting, by the controller, according to the size of the I/O request and the determined device type, a PHY for transmitting the I/O request from M PHYs configured for the determined device type; and
sending, by the controller, the I/O request to the to-be-accessed storage device using the selected PHY.

2. The method according to claim 1, wherein selecting the PHY comprises:
determining the M PHYs from the multiple PHYs according to the determined device type, wherein the storage devices of the determined device type are configured to communicate with the controller using any one of the M PHYs; and
selecting, from the M PHYs and according to the size of the I/O request, N PHYs for transmitting the I/O request, wherein the N PHYs are used to transmit an I/O request whose I/O size satisfies a preset condition, N is a positive integer, and N is not greater than M.

3. The method according to claim 2, wherein when N is a positive integer not less than 2, and the method further comprises:
selecting, according to degrees of busyness of the N PHYs, an idle PHY from the N PHYs as the PHY for transmitting the I/O request.

4. The method according to claim 1, wherein the method further comprises:
allocating the M PHYs to the determined device type according to a total quantity of the PHYs in the storage system and a percentage of a quantity of storage devices of the determined device type in the storage system; and
determining, in the M PHYs and according to statistical proportions of different size I/Os accessing the storage devices of the determined device type within a previous access period, PHYs for processing I/Os of different sizes within a current access period.

5. The method according to claim 1, wherein the method further comprises:
allocating the M PHYs to the determined device type according to a total quantity of the PHYs in the storage system and a percentage of a quantity of storage devices of the determined device type in the storage system; and
determining, in the M PHYs according to a preset policy, PHYs for processing I/Os of different sizes.

6. A computer device, comprising:
a memory storing instructions; and
a controller coupled to the memory configured to execute the instructions to:
receive an input output (I/O) request, wherein the I/O request includes a size and a to-be-accessed address of the I/O request, wherein the computer device is connected to storage devices of multiple different device types by a serial attached Small Computer System Interface (SAS), and the SAS comprises multiple physical layers (PHYs);
determine a device type of a to-be-accessed storage device according to the to-be-accessed address;
select, according to the size of the I/O request and the determined device type, a PHY for transmitting the I/O request from M PHYs configured for the determined device type; and
send the I/O request to the to-be-accessed storage device using the selected PHY.

7. The computer device according to claim 6, wherein selecting the PHY comprises:
determining the M PHYs from the multiple PHYs according to the determined device type, wherein the storage devices of the determined device type are configured to communicate with the controller by using any one of the M PHYs; and
selecting, from the M PHYs and according to the size of the I/O request, N PHYs for transmitting the I/O request, wherein the N PHYs are used to transmit an I/O request whose I/O size satisfies a preset condition, N is a positive integer, and N is not greater than M.

8. The computer device according to claim 7, wherein N is a positive integer not less than 2, and the controller is further configured to:
select, according to degrees of busyness of the N PHYs, an idle PHY from the N PHYs as the PHY for transmitting the I/O request.

9. The computer device according to claim 6, wherein the controller is further configured to:
allocate the M PHYs to the determined device type according to a total quantity of the PHYs in the storage system and a percentage of a quantity of storage devices of the determined device type in the storage system; and
determine, in the M PHYs and according to statistical proportions of different size I/Os accessing the storage device of the determined device type within the previous access period, PHYs for processing I/Os of different sizes within a next access period.

10. The computer device according to claim 6, wherein the controller is further configured to:
allocate the M PHYs to the storage device of the determined device type according to a total quantity of the PHYs in the storage system and a percentage of a quantity of storage devices of the determined device type in the storage system; and
determine, in the M PHYs according to a preset policy, PHYs for processing I/Os of different sizes.
